(19) United States
(12) Patent Application Publication
(10) Pub. No.: US 2008/0025297 A1
(43) Pub. Date: Jan. 31, 2008

(54) FACILITATING USE OF GENERIC ADDRESSES BY NETWORK APPLICATIONS OF VIRTUAL SERVERS

(75) Inventor: Vivek Kashyap, Beaverton, OR (US)

Correspondence Address: HESLIN ROTHENBERG FARLEY & MESITTI P.C., 5 COLUMBIA CIRCLE, ALBANY, NY, 12203, US

(73) Assignee: INTERNATIONAL BUSINESS MACHINES CORPORATION, Armonk, NY (US)

(21) Appl. No.: 11/460,702

(22) Filed: Jul. 28, 2006

(51) Int. Cl. H04L 12/56

(52) U.S. Cl. 370/389; 370/401

(57) ABSTRACT

A virtualized processing environment includes one or more virtual servers. Applications of a virtual server listen on any of the addresses associated with that virtual server. This includes listening on multiple addresses should multiple addresses be assigned to the virtual server. The applications specify a generic address that allows them to listen on any of the addresses. The applications need not know what addresses are assigned to the virtual server.

### TECHNICAL FIELD

This invention relates, in general, to virtualized processing environments, and in particular, to facilitating processing within those environments.

### BACKGROUND OF THE INVENTION

Enterprises are consolidating servers and workloads to reduce high maintenance overhead, including both administrative, as well as infrastructure, overhead. Server consolidation is complicated by the need to ensure performance, security, and resource guarantees for the workloads running on the same physical server.

Virtualization is a technique that aids in effective server consolidation. One type of virtualization is referred to as operating system virtualization, which creates multiple isolated environments within the same operating system. Each isolated environment, referred to herein as a virtual server, appears to the applications and users of that isolated environment as a separate host.

An important aspect of any virtualization solution is the need to isolate and virtualize the applications (e.g., network servers) running on the virtual servers. Each network application in a virtual server is to receive the client requests meant for that particular network application and is not to receive client requests not meant for that application. One way of ensuring that applications running on the virtual server only receive requests specifically meant for those applications is to physically assign a particular address to each virtual server for which network applications (e.g., network servers) listen on. The network applications then listen only on that one address.

### SUMMARY OF THE INVENTION

The assigning of one particular address to a virtual server in which the network applications listen on affects the ability of the network applications to listen on any of the addresses assigned to the virtual server. That is, it affects the ability of the network applications to use a generic address, such as INADDR_ANY, to listen on any of the addresses assigned to the virtual server. Therefore, a need exists for a capability that enables an application of the virtual server to listen on any (one or more) addresses of the virtual server. Similarly, there is a need for a capability that enables multiple virtual servers to listen on the same address and port as would be the case if the application listened on the same loopback address (e.g., 127.0.0.1) and port.

The shortcomings of the prior art are overcome and additional advantages are provided through the provision of a method of facilitating processing in a virtualized processing environment. The method includes, for instance, specifying by an application of a virtual server of the virtualized processing environment a generic address for the application to listen on for one or more requests; and associating with the generic address a plurality of addresses, wherein specification of the generic address enables the application to listen on the plurality of addresses for one or more requests.

System and computer program products corresponding to the above-summarized method are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a processing environment to incorporate and use one or more aspects of the present invention;

FIG. 2 depicts one embodiment of the logic associated with performing set-up to enable one or more aspects of the present invention;

FIG. 3 depicts one embodiment of virtual server interfaces of a virtual server used in accordance with an aspect of the present invention;

FIG. 4 depicts one embodiment of the logic associated with processing a request, in accordance with an aspect of the present invention;

FIG. 5 depicts one embodiment of a look-up table used to determine the appropriate destination for a request, in accordance with an aspect of the present invention; and

FIG. 6 depicts one embodiment of a computer program product incorporating one or more aspects of the present invention.

### BEST MODE FOR CARRYING OUT THE INVENTION

In accordance with an aspect of the present invention, a capability is provided for enabling applications of a virtual server to listen on any of the addresses associated with that virtual server. An application specifies a generic address (i.e., a wildcard, such as INADDR_ANY) and is able to listen on any of the one or more addresses assigned to that virtual server. The generic address is not tied to a single address, but is associated with any of the addresses of the virtual server. The application need not be aware of the addresses associated with the virtual server, and the list of addresses associated with the virtual server can be dynamically modified. This automatically allows the applications (e.g., network servers) of the virtual server to listen on any of the addresses (e.g., INADDR_ANY) of the modified list.

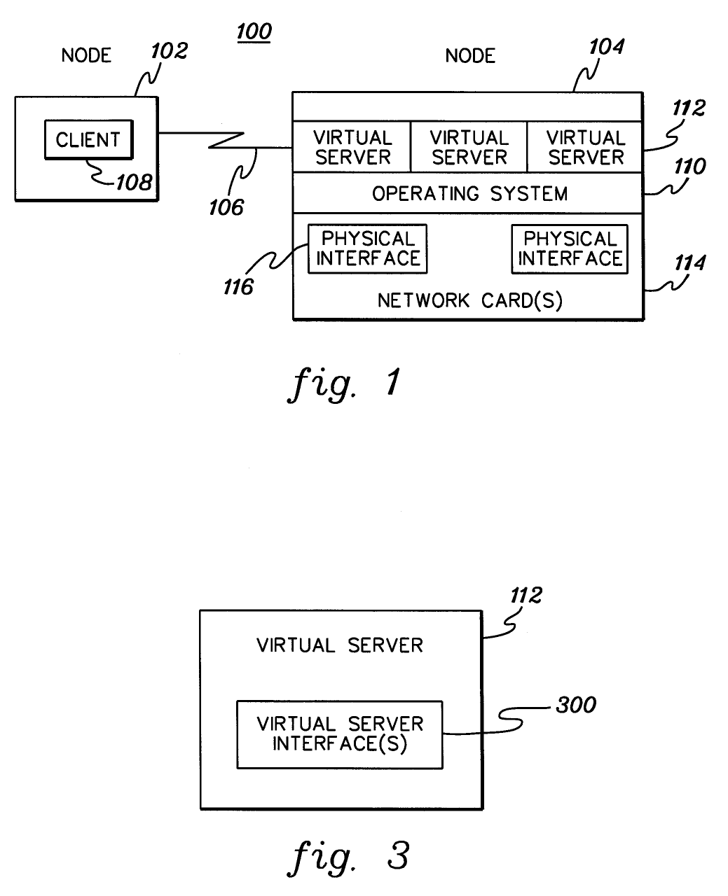

A plurality of virtual servers is typically included in a virtualized processing environment. However, a processing environment may include only one virtual server. One embodiment of a virtualized processing environment 100 incorporating and using one or more aspects of the present invention is described with reference to FIG. 1.

Virtualized processing environment 100 includes, for instance, a node 102 coupled to a node 104 via a connection 106. As examples, nodes 102 and 104 are UNIX machines and the connection is a network, such as an Ethernet network employing TCP/IP (Transmission Control Protocol/Internet Protocol). Node 102 executes one or more client applications 108 that generate requests to be serviced by node 104. Node 104 includes a virtualized operating system 110, such as the Linux Virtual Server, which is built using, for instance, source code, available online at www.linux-vserver.org. Virtualized operating system 110 is an operating system that includes a plurality of partitions, referred to herein as virtual servers 112. Each virtual server is created as an isolated environment within the same operating system, and each virtual server includes a unique root system, a shared set of system executables and libraries, and resources the root administrator assigned to the virtual server when it was created. To the applications and users of the virtual server, the virtual server appears to be an independent host.

The operating system is coupled to one or more network cards 114 of the node 104, which are used in communicating over the network. To facilitate communications between the operating system and network cards 114, one or more physical interfaces 116 are employed. For example, there is one physical interface 116 per network card. Each physical interface 116 is associated with one or more addresses (e.g., internet protocol (IP) addresses) assigned to the node.

Application servers of a node are usually written to listen on any address that is supported on the server (INADDR_ANY). In a virtualized environment, however, this is equivalent to listening on all addresses owned by this virtual server. An application (e.g., network server) in a virtual server is not to receive client requests that are not meant for it and yet is to accept requests on any of the addresses that are associated therewith. In effect, a server, such as a web server listening on a particular port, e.g., port 80, should be able to run unmodified on multiple virtual servers on the same machine, but at the same time only accept requests actually received on the virtual server's list of addresses.

In accordance with an aspect of the present invention, each virtual server (or a subset thereof) is assigned one or more addresses of node 104 allowing requests that come in on the addresses to be forwarded to the appropriate virtual server. In one embodiment, each virtual server is assigned one or more unique addresses of the node. The addresses of one virtual server are independent from the addresses of another virtual server, in this example.

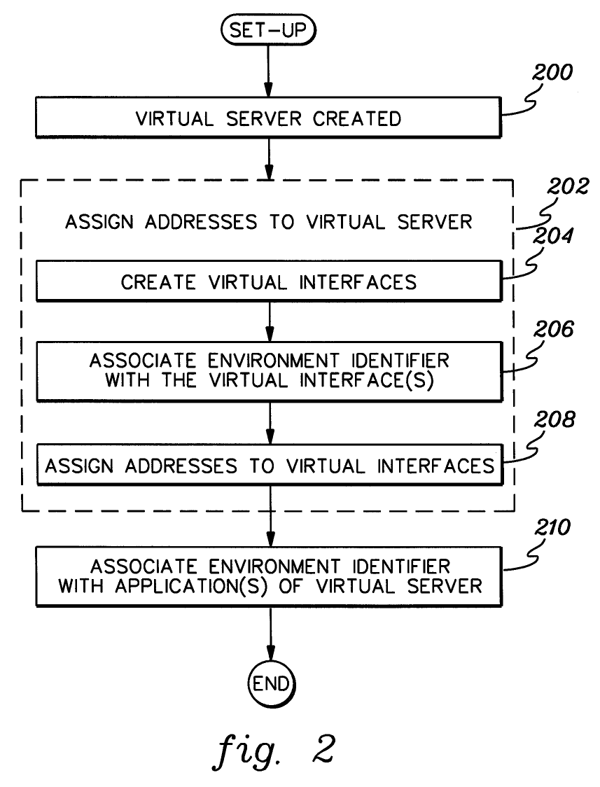

To assign addresses to particular virtual servers and to ensure requests are forwarded to the appropriate virtual server, certain set-up is performed on the server node. One embodiment of the set-up performed in order to enable multiple addresses to be associated with a virtual server and to allow applications of that virtual server to listen on any of the addresses of that virtual server is described with reference to FIG. 2.

Initially, in response to creating or having a virtual server, STEP 200, one or more addresses of node 104 are assigned to the virtual server, STEP 202. In one embodiment, the addresses are assigned to virtual server interfaces of the virtual server. Referring to FIG. 3, as an example, for each virtual server 112, one virtual server interface 300 is created for each physical interface of node 104 (or a subset thereof), STEP 204 (FIG. 2). The physical interface is directly associated with a device (e.g., Ethernet), while the virtual interface is associated with the physical interface. Each virtual interface is assigned an environment identifier (e.g., a virtual server id) associating the interface with a particular virtual server, STEP 206. Each selected address of the node is assigned to a virtual interface, STEP 208. Thus, an address is assigned to a particular virtual server.

To create a virtual interface, in one example, a data structure is created that includes information regarding the interface, such as, for instance, an identifier of the interface, an identifier of the virtual server to which this virtual interface is assigned, an identifier of the physical interface associated with this virtual interface, and a listing of the one or more addresses assigned to the virtual interface. A virtual interface can be created in a number of different ways, including, but not limited to, the manner in which the physical interface is created. However, instead of associating the interface with a device, as with the physical interface, the virtual interface is associated with a physical interface. In one example, a command is used to create the virtual interfaces.

Although, in the above embodiment, an address is assigned to a virtual server via a virtual interface, in other embodiments, virtual interfaces are not used in assigning the addresses. In an embodiment in which virtual interfaces are not used, the virtual server identifier is recorded with the addresses that are directly associated with the physical interfaces.

Returning to FIG. 2, in addition to assigning the addresses to the virtual server, the set-up includes associating the environment id of the virtual server with application(s) of that server, STEP 210. For example, when an application, such as a network server, of the virtual server registers with the operating system (referred to as bind( ) in UNIX systems) to listen on a port and address, e.g., INADDR_ANY, the operating system records the environment identifier associated with that application (e.g., the virtual server id of the virtual server executing the application). This environment identifier is then usable for an in-kernel look-up to find the appropriate endpoint of an application to receive a request, as described below.

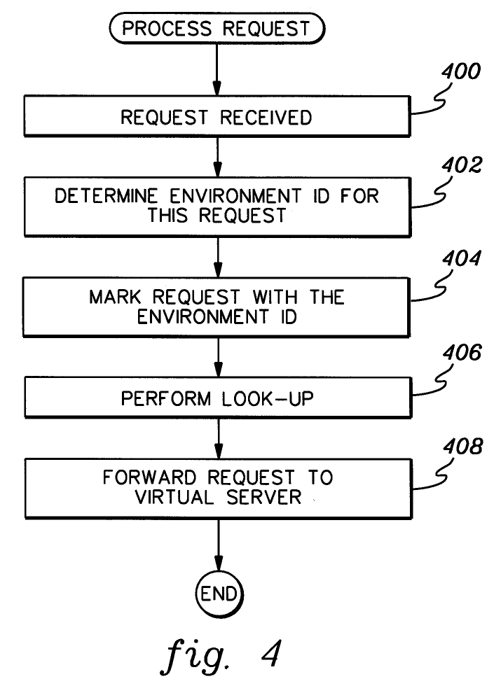

By performing the above set-up, an application running on a virtual server can specify INADDR_ANY allowing the application to listen on any (i.e., one or more) of the virtual addresses associated with the virtual server without requiring the application to know which addresses are associated therewith. The list of addresses associated with the virtual server is modifiable and those addresses are automatically included, as well. The set-up enables requests (e.g., packets) received by the node to be automatically directed to the correct virtual server, even though the application specifies INADDR_ANY and there are a plurality of addresses associated with the virtual server. This is described further with reference to FIG. 4, in which one embodiment of the logic associated with receiving a packet is described.

Initially, a request is received at a server node from a client, STEP 400. The request includes a destination address (e.g., an IP address) that directs the request to the server node. In response to receiving the request, the address is used to determine an environment identifier to be associated with the request, STEP 402. For example, the request arrives at the network card and the physical interface of that card takes the request and passes it to the operating system. The operating system searches a data structure (e.g., table) for the IP address included in the packet. The address, as noted earlier, may be associated with a virtual interface, which is in turn associated with a virtual server. Therefore, the virtual server id is determined from the address directly or from the associated virtual interface. The identifier of the virtual server is added to the request by the operating system, STEP 404.

The operating system sends the updated request to the protocol layer (e.g., TCP/IP layer) of the operating system for further processing. The protocol layer performs a look-up in a data structure located within the operating system to find the relevant listener, i.e., the particular application (e.g., network server) to service the request, STEP 406.

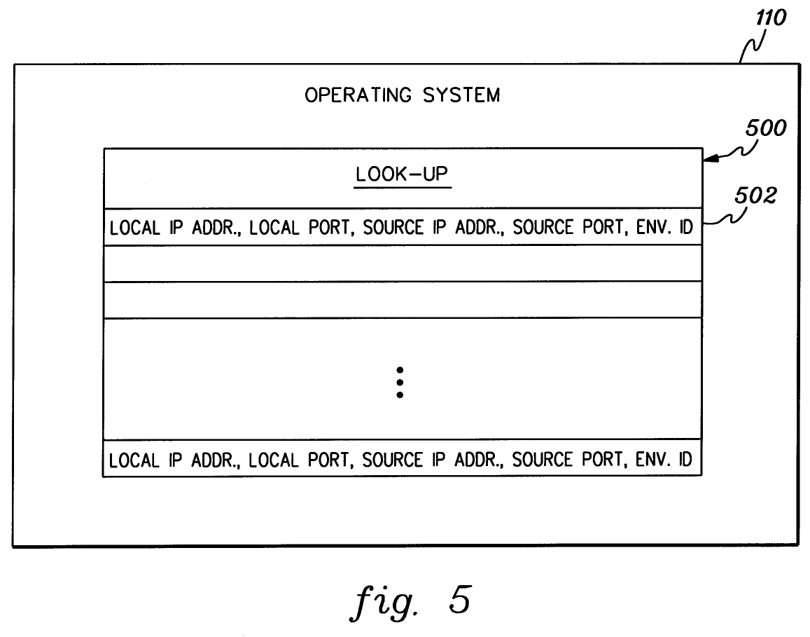

To further explain, within the operating system, as one example, are one or more look-up tables 500 (FIG. 5), each having one or more rows of data 502. Each look-up table is for a particular communications protocol, in one example. For instance, the table depicted in FIG. 5 is for TCP/IP. If there is another protocol, then another table is included, in this example. Each row 502 includes, for instance, a local IP address, which is the address an application intends to listen on (this may be indicated as INADDR_ANY), the port the application is listening on, the IP address of the source of the request, the port of the source, and the environment id of the virtual server. The local address, local port and environment id are added to the table when the application registers with the operating system, and the source address and port are added in response to connecting to the local node.

Returning to FIG. 4, when the request is received at the protocol layer, the destination address, destination port and environment identifier are used to determine the endpoint (local IP address, local port) of the application to which the request is to be forwarded. The request is forwarded to the appropriate application running in the virtual server, STEP 408 (FIG. 4). This enables an application of a virtual server to listen on any address of the virtual server, including multiple addresses.

One or more aspects of the present invention can be included in an article of manufacture (e.g., one or more computer program products) having, for instance, computer useable media. The media has therein, for instance, computer readable program code means of logic (e.g., instructions, code, commands, etc.) to provide and facilitate the capabilities of the present invention. The article of manufacture can be included as a part of a computer system or sold separately.

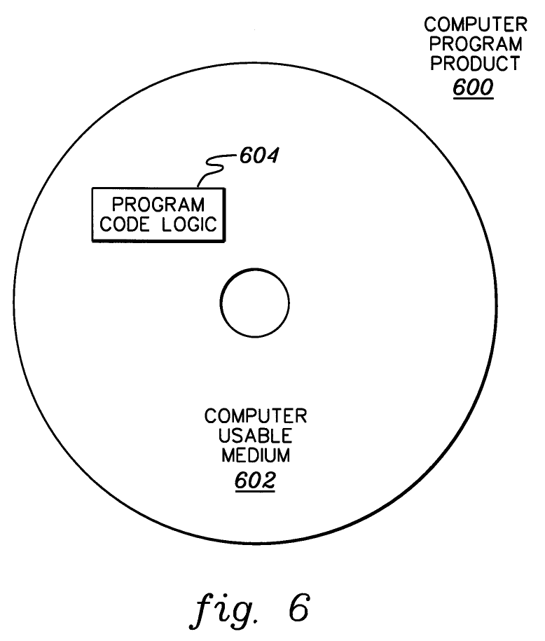

One example of an article of manufacture or a computer program product incorporating one or more aspects of the present invention is described with reference to FIG. 6. A computer program product 600 includes, for instance, one or more computer usable media 602 to store computer readable program code means or logic 604 thereon to provide and facilitate one or more aspects of the present invention. The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, a random access memory (RAM), a read-only memory (ROM), a rigid magnetic disk and an optical disk. Examples of optical disks include compact disk-read only memory (CD-ROM), compact disk-read/write (CD-R/W) and DVD.

A sequence of program instructions or a logical assembly of one or more interrelated modules defined by one or more computer readable program code means or logic direct the performance of one or more aspects of the present invention.

Advantageously, in accordance with one or more aspects of the present invention, applications, such as network servers, within a virtual server receive connection requests meant for any address associated with that virtual server. That is, an application can specify a generic address, e.g., INADDR_ANY, and receive connection requests on any addresses, including multiple addresses, associated with the virtual server.

Further, since the environment id is associated with the servers, then as an extension, addresses that are otherwise shareable (e.g., applications expect to use 127.0.0.1 for loopback), can be isolated among the servers and even used in applications. Some servers, for example, always open a socket on 127.0.0.1. With the environment id associated with the look-up table, such use will also work in virtual servers. In this setup, the communicating application is also on the same vserver, therefore the virtual server id is associated based on the application running in the virtual server rather than an address lookup. However, the lookup table is looked up the same way to isolate the packets.

With the above capabilities, full isolation is provided for the virtual servers, yet enabling applications of the virtual servers to specify INADDR_ANY or another generic address. Network services across virtual servers are supported. Support for the same network servers across multiple containers using the same port and address is supported. By modifying the bind to utilize the environment id (easily acquired since the calls are made from within the context), multiple endpoints with INADDR_ANY, PORT_a are allowed to be set up. Thus, clients in separate virtual contexts can run the same daemons (e.g., FTPD or TELNETD) listening on any address.

Although various embodiments are described above, these are only examples. Many changes, additions or deletions may be made without departing from the spirit of the present invention. For example, processing environments other than those described herein may include one or more aspects of the present invention. Further, the nodes may be other than UNIX machines, the operating system other than Linux Virtual Server, and the connection may be other than Ethernet employing TCP/IP. The environment may include more client and/or server nodes, and/or a node may be both a client and a server. Further, the environment may include more or less virtual servers. Although the term virtual server is used herein, a virtual server is meant to include any type of partition which is to be isolated from other partitions of a node. Further, although INADDR_ANY is used, any other indications to specify that an application is to listen on any address of the node is useable. There may be a plurality of nodes in the virtualized processing environment and one or more of the nodes may be virtualized. Additionally, although in this example one look-up table is provided for each communications protocol, in other embodiments, one table may include multiple protocols. Further, the look-up table can be any type of data structure. Many other changes, additions, deletions may be made without departing from the spirit of the present invention.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The capabilities of one or more aspects of the present invention can be implemented in software, firmware, hardware, or some combination thereof. At least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

Although preferred embodiments have been depicted and described in detail there, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating processing in a virtualized processing environment, said method comprising:
specifying by an application of a virtual server of the virtualized processing environment a generic address for the application to listen on for one or more requests; and
associating with the generic address a plurality of addresses, wherein specification of the generic address enables the application to listen on the plurality of addresses for one or more requests.

2. The method of claim 1, wherein the specifying comprises specifying by the application that it is listening on any address assigned to the virtual server.

3. The method of claim 1, wherein the associating comprises assigning the plurality of addresses to the virtual server, wherein the assigning the plurality of addresses to the virtual server associates the plurality of addresses with the generic address.

4. The method of claim 3, wherein the assigning comprises:
creating one or more virtual interfaces for the virtual server;
associating an environment identifier of the virtual server with the one or more virtual interfaces; and
assigning the plurality of addresses to at least one virtual interface of the one or more virtual interfaces.

5. The method of claim 3, wherein the assigning comprises recording an environment identifier of the virtual server with the plurality of addresses.

6. The method of claim 1, further comprising determining whether a request received by the virtualized processing environment is to be processed by the application, wherein the determining comprises employing an environment identifier associated with the request in a look-up of an endpoint to receive the request, wherein the application is to process the request in response to the endpoint being associated with that application.

7. The method of claim 6, further comprising associating the environment identifier with the request, said associating comprising:
determining the environment identifier, the determining comprising checking which virtual server of the virtualized processing environment is assigned a destination address of the request; and
associating the environment identifier of that virtual server with the request.

8. The method of claim 6, further comprising including the environment identifier in a data structure used in the look-up.

9. The method of claim 1, further comprising associating an environment identifier of the virtual server with the application, said environment identifier to facilitate identifying incoming requests to be processed by the application.

10. A system of facilitating processing in a virtualized processing environment, said system comprising:
a virtual server of the virtualized processing environment; and
an application to be executed within the virtual server, said application to provide a generic address for the application to listen on for one or more requests, said generic address being associated with a plurality of addresses of the virtual server.

11. The system of claim 10, wherein the virtual server is assigned the plurality of addresses, and wherein the assigning the plurality of addresses to the virtual server associates the plurality of addresses with the generic address.

12. The system of claim 10, further comprising a component of the virtualized processing environment to determine whether a request received by the virtualized processing environment is to be processed by the application, wherein the determining comprises employing an environment identifier associated with the request in a look-up of an endpoint to receive the request, wherein the application is to process the request in response to the endpoint being associated with that application.

13. The system of claim 10, wherein associated with the application is an environment identifier of the virtual server, said environment identifier to facilitate identifying incoming requests to be processed by the application.

14. An article of manufacture comprising:
at least one computer usable medium having computer readable program code logic to facilitate processing in a virtualized processing environment, said computer readable program code logic when executing performing the following:
specifying by an application of a virtual server of the virtualized processing environment a generic address for the application to listen on for one or more requests; and
associating with the generic address a plurality of addresses, wherein specification of the generic address enables the application to listen on the plurality of addresses for one or more requests.

15. The article of manufacture of claim 14, wherein the specifying comprises specifying by the application that it is listening on any address assigned to the virtual server.

16. The article of manufacture of claim 14, wherein the associating comprises assigning the plurality of addresses to the virtual server, wherein the assigning of the plurality of addresses to the virtual server associates the plurality of addresses with the generic address.

17. The article of manufacture of claim 16, wherein the assigning comprises:
creating one or more virtual interfaces for the virtual server;
associating an environment identifier of the virtual server with the one or more virtual interfaces; and
assigning the plurality of addresses to at least one virtual interface of the one or more virtual interfaces.

18. The article of manufacture of claim 14, further comprising determining whether a request received by the virtualized processing environment is to be processed by the application, wherein the determining comprises employing an environment identifier associated with the request in a look-up of an endpoint to receive the request, wherein the application is to process the request in response to the endpoint being associated with that application.

19. The article of manufacture of claim 18, further comprising associating the environment identifier with the request, said associating comprising:
determining the environment identifier, the determining comprising checking which virtual server of the virtualized processing environment is assigned a destination address of the request; and
associating the environment identifier of that virtual server with the request.

20. The article of manufacture of claim 14, further comprising associating an environment identifier of the virtual server with the application, said environment identifier to facilitate identifying incoming requests to be processed by the application.
